(19) United States
(12) Patent Application Publication
(10) Pub. No.: US 2026/0296029 A1
(43) Pub. Date: Oct. 1, 2026

(54) PRINTING APPARATUS, METHOD OF CONTROLLING PRINTING APPARATUS, AND STORAGE MEDIUM

(71) Applicant: CANON KABUSHIKI KAISHA, Tokyo (JP)

(72) Inventors: RYOSUKE ARAKI, Kanagawa (JP); SEIJI SUZUKI, Kanagawa (JP); RUI SEKINE, Kanagawa (JP); YOSHIKAZU SAITO, Tokyo (JP)

(21) Appl. No.: 19/576,001

(22) Filed: Mar. 24, 2026

(30) Foreign Application Priority Data
Mar. 28, 2025 (JP) 2025-056441

(51) Int. Cl. B41J 2/165

(52) U.S. Cl. CPC B41J 2/16532; B41J 2/16552; B41J 2002/16573; B41P 2235/27

(57) ABSTRACT

An object of the present disclosure is to stabilize the tightness of contact between a print head and suction unit. An embodiment according to the present disclosure is a printing apparatus including: a print head; a negative pressure application unit configured to come into abutment with and apply a negative pressure to the print head; a negative pressure tank configured to store a negative pressure to be applied to the negative pressure application unit; and a cleaning liquid supply unit configured to supply a cleaning liquid. The cleaning liquid supply unit supplies the cleaning liquid to the negative pressure application unit before the negative pressure application unit executes a negative pressure suction operation on the print head.

### BACKGROUND

### Field of the Technology

The present disclosure relates to a printing apparatus, a method of controlling a printing apparatus, and a storage medium.

### Description of the Related of Art

Line-head printing apparatuses have been known which perform printing by ejecting droplets from a print head in synchronization with conveyance of a print medium in a state where the print head does not move relative to the main body. In such a printing apparatus, the ink ejected from the nozzles in an image printing process sometimes does not land on the sheet but floats and gets attached to nozzles. This may cause misalignment of ejected ink droplets and deteriorate image quality.

Japanese Patent Laid-Open No. 2011-240550 discloses a cleaning mechanism that forcibly sucks an ink out of a print head for the purpose of recovery. This cleaning mechanism sucks all nozzles while moving its suction port in the direction in which the nozzle array is formed.

### SUMMARY

Here, with the configuration of Japanese Patent Laid-Open No. 2011-240550, in a case where the print head and a suction unit are brought into abutment with each other and a negative pressure is charged at the start of the suction operation, the surfaces of the print head and the suction abutting each other may be dry. In this case, the frictional resistance on these abutment surfaces is high. This may result in unstable contact between the print head and the suction unit. Charging a negative pressure in this unstably contacting state cannot generate a desired negative pressure.

In view of the above problem, an object of the present disclosure is to stabilize the tightness of contact between a print head and a suction unit.

An embodiment according to the present disclosure is a printing apparatus including: a print head; a negative pressure application unit configured to come into abutment with and apply a negative pressure to the print head; a negative pressure tank configured to store a negative pressure to be applied to the negative pressure application unit; and a cleaning liquid supply unit configured to supply a cleaning liquid. The cleaning liquid supply unit supplies the cleaning liquid to the negative pressure application unit before the negative pressure application unit executes a negative pressure suction operation on the print head.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an example of a schematic configuration of a printing apparatus;

FIG. 2 is a perspective view of a print head;

FIG. 3 is a perspective view illustrating a configuration of a capping tray;

FIG. 4 is a perspective view illustrating a configuration of a cleaning tray;

FIG. 5 is a diagram illustrating a channel configuration in a printing module;

FIG. 6 is a flowchart of a maintenance process;

FIGS. 7A and 7B are views illustrating a positional relationship between a print head and a negative pressure application unit;

FIG. 8 is a flowchart of a channel cleaning process; and

FIG. 9 is a flowchart of a process of supplying a cleaning liquid to the negative pressure application unit.

### DESCRIPTION OF THE EMBODIMENTS

A preferred embodiment of the present disclosure will be specifically described below with reference to the accompanying drawings. Note that the following embodiment does not limit the contents of the present disclosure, and not all of the combinations of the features described in the following embodiment are necessarily essential for the solution to be provided by the present disclosure. Note that identical constituent elements are denoted by the same reference numeral.

### First Embodiment

### Overall Configurations of Printing Apparatus

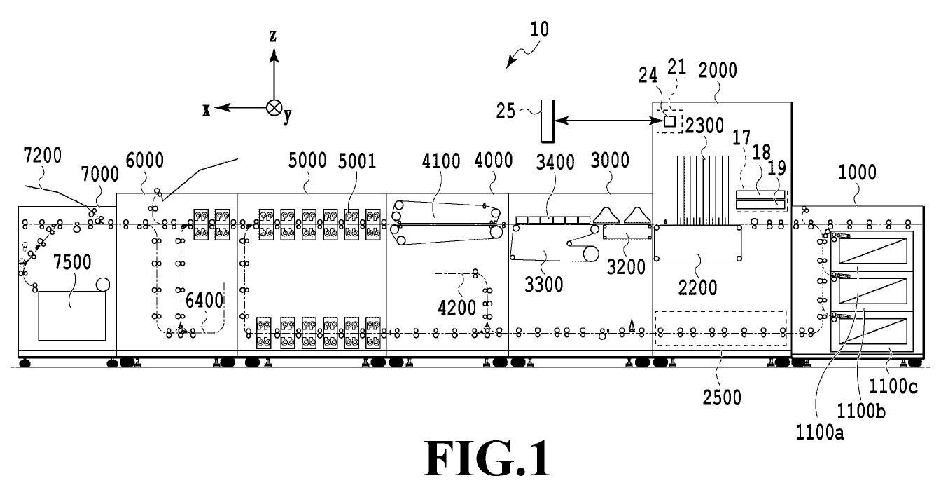

An overall configuration of a printing apparatus 10 in a first embodiment will be described below with reference to the drawings. Note that, in drawings, arrows x and y indicate horizontal directions perpendicular to each other, and arrow z indicates a vertical direction. The x direction is as a rule a conveyance direction in which a sheet S as a print medium is conveyed inside the printing apparatus 10, and in particular corresponds to a conveyance direction in which the sheet S is conveyed in a printing unit 2300. Also, in FIG. 1, a direction toward the top of the apparatus is defined as "upper direction," a direction from the right to the left is defined as "longitudinal direction," and a direction from the near side relative to the sheet surface to the far side perpendicular to the sheet conveyance direction is defined as "sheet width direction." Moreover, the near side relative to the sheet surface is defined as the front side of the apparatus, and the far side relative to the sheet surface is defined as the back side of the apparatus.

FIG. 1 is a schematic diagram illustrating an example of a schematic configuration of the printing apparatus 10. The printing apparatus 10 is a sheet-fed printing apparatus that manufactures a printed product by forming an ink image on a sheet S using two types of liquids, namely a reaction liquid and inks. The printing apparatus 10 in the present embodiment includes a sheet feeding module 1000, a printing module 2000, a drying module 3000, a fixing module 4000, a cooling module 5000, an inverting module 6000, and a discharged sheet stacking module 7000. The sheet S in the form of a cut sheet fed from the sheet feeding module 1000 is conveyed along a conveyance path to be subjected to a process by each module and is discharged to the discharged sheet stacking module 7000.

In the sheet feeding module 1000, three storages 1100a to 1100c accommodating sheets S are disposed. The storages 1100a to 1100c are each configured to be capable of being drawn out toward the front side of the apparatus (near side relative to the sheet surface). The sheets S in each of the storages 1100a to 1100c are fed one by one by a separation belt and a conveyance roller and conveyed to the printing module 2000. Note that the number of storages is not limited to three (1100a to 1100c), and a configuration with one, two, or four or more storages may be employed.

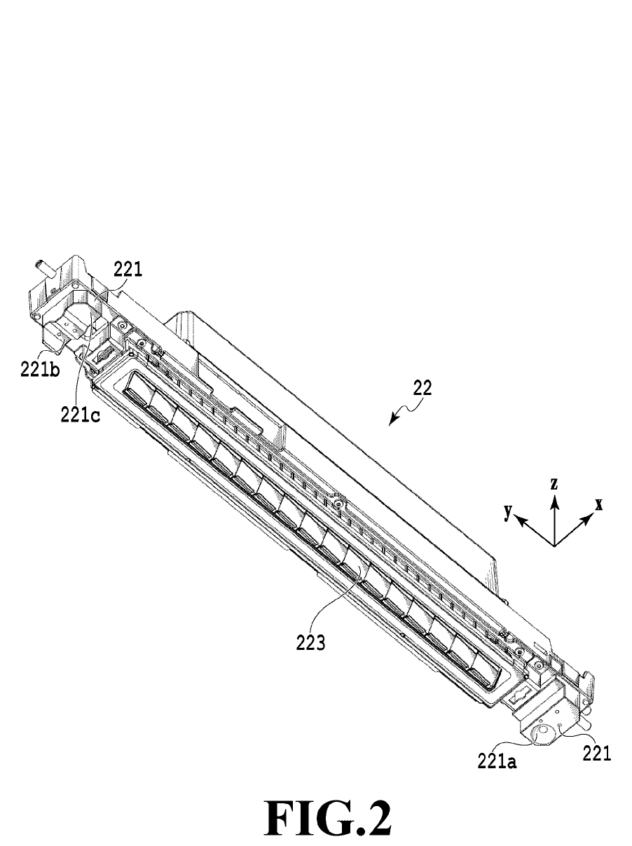

The printing module 2000 includes a pre-image-formation registration correction unit (not illustrated), a printing belt unit 2200, the printing unit 2300, and a maintenance unit 17. The sheet S conveyed from the sheet feeding module 1000 is subjected to correction of the sheet's tilt and position by the pre-image-formation registration correction unit and conveyed to the printing belt unit 2200. The printing unit 2300 is disposed at a position facing the printing belt unit 2200 across the conveyance path for the sheet S. The printing unit 2300 performs printing processing on the conveyed sheet S from above the sheet S with print heads 22 (see FIG. 2) to form an image. The sheet S is held by suction and conveyed by the printing belt unit 2200, thus leaving a clearance between the sheet S and the print heads 22. Multiple print heads 22 are arrayed along the conveyance direction (x direction).

The printing unit 2300 in the present embodiment includes a total of five line print heads 22 for four colors of yellow (Y), magenta (M), cyan (C), and black (Bk) and a reaction liquid (P). Note that the number of colors and the number of print heads are not limited to five. As for the inkjet method, it is possible to employ a method using heating elements, a method using piezoelectric elements, a method using electrostatic elements, a method using micro-electromechanical systems (MEMS) elements, or the like. The ink of each color is supplied to the corresponding print head 22 through a corresponding ink tube from an ink tank (not illustrated).

The sheet S printed by the printing unit 2300 is conveyed by the printing belt unit 2200. An inline scanner (not illustrated) disposed downstream of the printing unit 2300 in the conveyance direction may be used to detect misalignment of the image formed on the sheet S and its color densities to correct images to be printed.

The drying module 3000 includes a decoupling unit 3200, a drying belt unit 3300, and a warm air blowing unit 3400. The drying module 3000 is a module that reduces the liquid components contained in the inks applied to the sheet S by the printing unit 2300 to enhance the fixability of the inks to the sheet S. The sheet S printed by the printing unit 2300 of the printing module 2000 is conveyed to the decoupling unit 3200 disposed in the drying module 3000. The decoupling unit 3200 is capable of conveying the sheet S using an air pressure from above and a friction with a belt, and lightly holds and conveys the sheet S on the belt to prevent misalignment of the sheet S on the printing belt unit 2200, on which ink images are formed. The sheet S conveyed from the decoupling unit 3200 is held by suction and conveyed by the drying belt unit 3300 and, at the same time, receives hot air from the warm air blowing unit 3400 disposed above the belt. As a result, the surface of the sheet S to which the inks have been applied becomes dried. Incidentally, the drying method may combine the method that applies hot air with a method that irradiates the surface of the sheet S with electromagnetic waves (such as ultraviolet rays or infrared rays) or a conduction heat transfer method that uses contact with a heating body.

The fixing module 4000 includes a fixing belt unit 4100. The fixing belt unit 4100 includes a top belt unit and a bottom belt unit. The sheet S conveyed from the drying module 3000 is passed between the top and bottom belt units, which are heated. This fixes the inks to the sheet S.

The cooling module 5000 includes multiple cooling units 5001. The cooling units 5001 cool the hot sheet S conveyed from the fixing module 4000. The cooling units 5001 cool the sheet S by taking ambient air into a cooling box with a fan, raising the pressure inside the cooling box, and applying air jetting from a nozzle formed in a conveyance guide to the sheet S. The cooling units 5001 are disposed on opposite sides of the conveyance path and are capable of cooling the sheet S from both sides. Also, the cooling module 5000 incorporates a conveyance path switching unit, with which the conveyance path for the sheet S can be switched depending on whether to convey the sheet S to the inverting module 6000 or to convey the sheet S to a duplex conveyance path to be used for duplex printing. In the case of duplex printing, the sheet S is conveyed to a conveyance path downstream of the cooling module 5000 and further conveyed along duplex conveyance paths in the fixing module 4000, the drying module 3000, the printing module 2000, and the sheet feeding module 1000. At the printing module 2000, the sheet S is conveyed along a duplex conveyance path 2500. The sheet S is then conveyed to the pre-image-formation registration correction unit, the printing belt unit 2200, and the printing unit 2300 of the printing module 2000 and printed by the printing unit again. The duplex conveyance unit of the fixing module 4000 is provided with an inverting unit 1 (4200) that inverts the sheet S.

The inverting module 6000 includes an inverting unit 2 (6400), and is capable of inverting the sheet S conveyed thereto using the inverting unit 2 (6400) and freely changing the orientation of the front and back sides of the sheet S to be discharged.

The discharged sheet stacking module 7000 includes a top tray 7200 and a stacking unit 7500, and aligns and stacks sheets S conveyed from the inverting module 6000.

The maintenance unit 17 is a unit including mechanisms that recover the ejection performance of the print heads. Examples of such mechanisms include capping mechanisms that protect the ink ejection surfaces of the print heads 22, wiper mechanisms that wipe the ink ejection surfaces, and suction mechanisms that suck the inks inside the print heads from the ink ejection surfaces with a negative pressure. The maintenance unit 17 also includes a driving mechanism and a rail (not illustrated). The maintenance unit 17 is capable of reciprocally moving in a horizontal direction along the rail, and moves to immediately under the print heads 22 in a case of performing maintenance of the print heads while moving to a position away from immediately under the print heads in a case of not performing maintenance. The maintenance unit 17 includes a capping tray 18 including the capping mechanisms and a cleaning tray 19 including the wiper mechanisms and the suction mechanisms. The capping tray 18 and the cleaning tray 19 are configured to be capable of reciprocally moving in a horizontal direction independently of each other by means of the driving mechanism and the rail (not illustrated). Incidentally, in a case where the capping mechanisms cap the print heads 22, only the capping tray 18 may move or the whole maintenance unit 17 including the cleaning tray 19 may move.

A control unit 21 is a unit that controls units of the printing apparatus 10. The control unit 21 includes a central processing unit (CPU), storage devices such as a read-only memory (ROM) and a random-access memory (RAM), a controller including various control units, an external interface, and an operation unit 24 on which the user performs input and output operations. Operation of the printing apparatus 10 is controlled in accordance with instructions input through the operation unit 24 and instructions from a host apparatus 25, such as a host computer, connected to the controller through the external interface.

### Configuration of Print Head

FIG. 2 is a perspective view of a print head 22. As illustrated in FIG. 2, the print head 22 includes nozzle plates 223 aligned in the longitudinal direction of the print head (sheet width direction, y direction), each nozzle plate 223 including multiple nozzles that eject the ink. In each nozzle plate 223, multiple nozzle arrays each formed of multiple nozzles are formed. The print head 22 includes positioning portions 221 at both ends. Specifically, the print head 22 includes a first abutment portion 221a formed by a concave portion including a conical inclined surface on the near side in the longitudinal direction of the head (-y side). The print head 22 also includes a second abutment portion 221b formed by a groove portion with two flat surfaces in a V-shape and a third abutment portion 221c formed by a flat portion on the far side in the longitudinal direction of the head (+y side).

### Configuration of Maintenance Unit

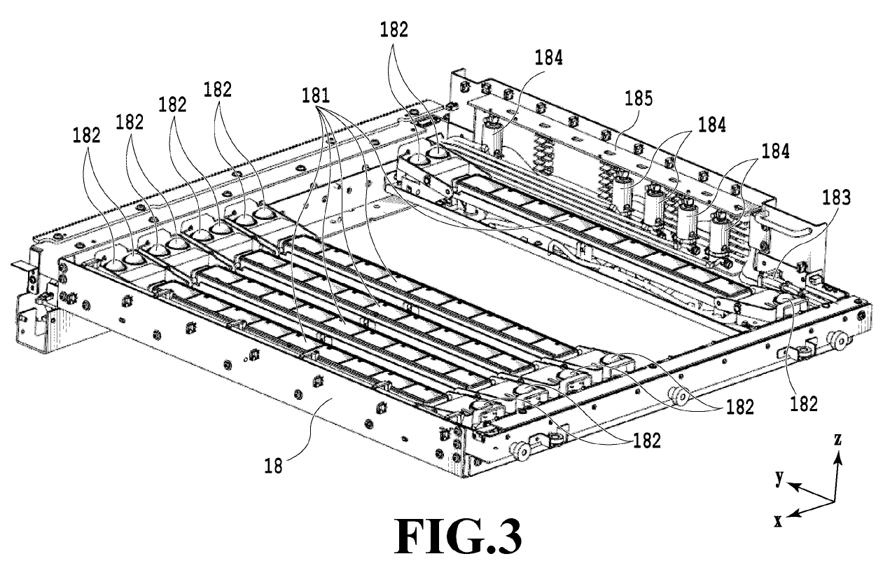

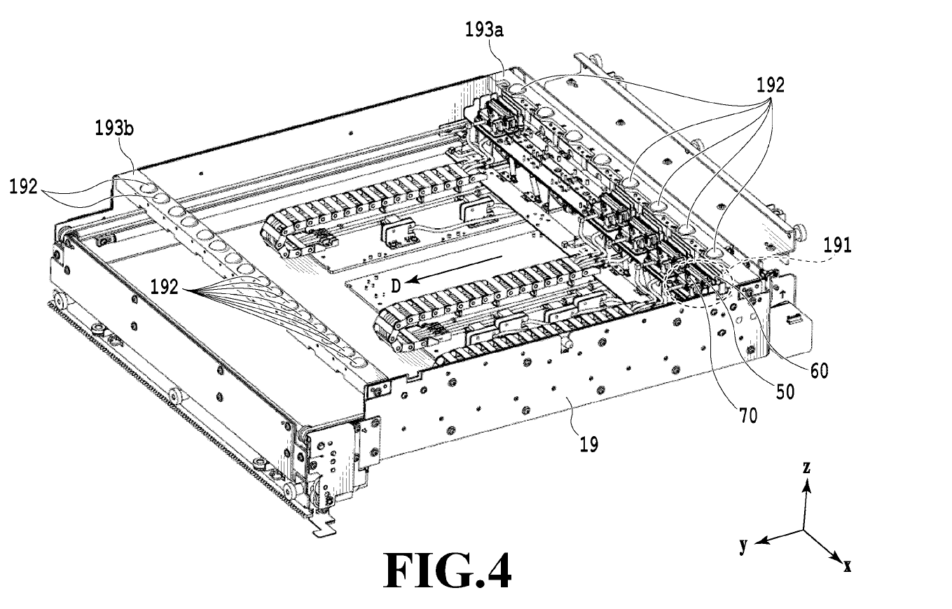

FIG. 3 is a perspective view illustrating a configuration of the capping tray 18. FIG. 4 is a perspective view illustrating a configuration of the cleaning tray 19. A configuration of the maintenance unit 17 will be described below with reference to FIGS. 3 and 4.

In the present embodiment, the maintenance unit 17 includes the capping tray 18 in which capping mechanisms 181 (see FIG. 3) are disposed, and the cleaning tray 19 in which cleaning mechanisms 191 (see FIG. 4) are disposed. The capping tray 18 and the cleaning tray 19 are configured to be capable of moving in the longitudinal direction of the apparatus (x direction) by means of a driving motor and a rail provided on the housing (not illustrated). Note that, in the present embodiment, because of the configuration with a total of five print heads 22, a total of five capping mechanisms 181 and a total of five cleaning mechanisms 191 are provided corresponding to the print heads 22.

As illustrated in FIG. 3, each capping mechanism 181 in the capping tray 18 includes multiple spherical print head positioning members 182 for positioning the print head 22. The print head positioning members 182 are disposed at front and rear portions of the capping mechanism 181 in the sheet width direction (y direction). Three print head positioning members 182 are used to position one print head 22 with respect to the capping mechanism 181; one is disposed on the near side (-y side) of the capping mechanism 181, and two on the far side (+y side). The above-described positioning portions 221 provided at both ends of the print head 22 are brought into abutment with the print head positioning members 182 of the capping mechanism 181 to position the print head 22 and the capping mechanism 181. By being positioned with respect to the print head 22, the capping mechanism 181 is capable of, for example, protecting the nozzle plates 223 of the print head 22 and performing negative pressure suction with a negative pressure suction mechanism to be described later.

As illustrated in FIG. 4, the cleaning tray 19 includes multiple spherical print head positioning members 192 for positioning the multiple print heads 22. The print head positioning members 192 are disposed on front and rear sides in the sheet width direction (y direction) inside the cleaning tray 19 and held by beam members 193a and 193b disposed to extend in the sheet conveyance direction (x direction). Three print head positioning members 192 are used to position one print head 22 with respect to the cleaning tray 19. One print head positioning member 192 is disposed on the near side beam member 193a (on the -y side) and two print head positioning members 192 are disposed on the far side beam member 193b (+y side) inside the cleaning tray 19. The above-described positioning portions 221 provided at both ends of the print head 22 are brought into abutment with the print head positioning members 192 of the cleaning tray 19 to position the print head 22 and the cleaning tray 19.

Note that the positioning configuration is not limited to the configuration using spherical positioning members, and may be a configuration in which a portion of the print head 22 is brought into abutment with an inner portion of the cleaning tray 19. Alternatively, the positioning configuration may be a configuration in which holes and pins provided to the cleaning tray 19 and the print head 22 are used to position them.

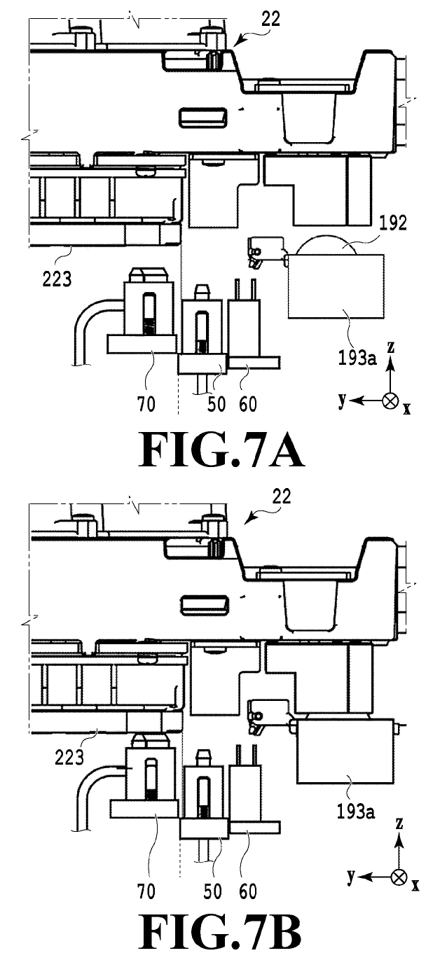

The cleaning tray 19 is provided with five cleaning mechanisms 191 corresponding to the number of print heads 22, as mentioned earlier. Each cleaning mechanism 191 includes a cleaning liquid application unit 50, a liquid removal unit 60, and a negative pressure application unit 70. The cleaning liquid application unit 50 is an application unit that applies a cleaning liquid to the nozzle plates 223 of the print head 22. The liquid removal unit 60 is a wiper mechanism for removing inks, paper dust, and the cleaning liquid attached to the nozzle plates 223 of the print head 22. The negative pressure application unit 70 is a suction mechanism for removing inks fixedly attached to nozzle portions and removing bubbles inside ink channels by applying a negative pressure to the nozzle plates 223 of the print head 22. The cleaning tray 19 includes a moving mechanism (not illustrated) that moves the cleaning mechanisms 191 along a wiping direction D perpendicular to the sheet conveyance direction (x direction) as illustrated in FIG. 4. Each cleaning mechanism 191 uses the cleaning liquid application unit 50, the liquid removal unit 60, and the negative pressure application unit 70 in combination with one another to remove inks and dust on the nozzle surface of the print head 22. In the present embodiment, the entire nozzle surface is cleaned by bringing the negative pressure application unit 70, which is a suction unit, into abutment with a nozzle plate 223 (see FIG. 7B) and moving the abutting negative pressure application unit 70 in the nozzle array direction (y direction) while sucking the nozzle plate 223 with the negative pressure application unit 70.

### Channel Configuration

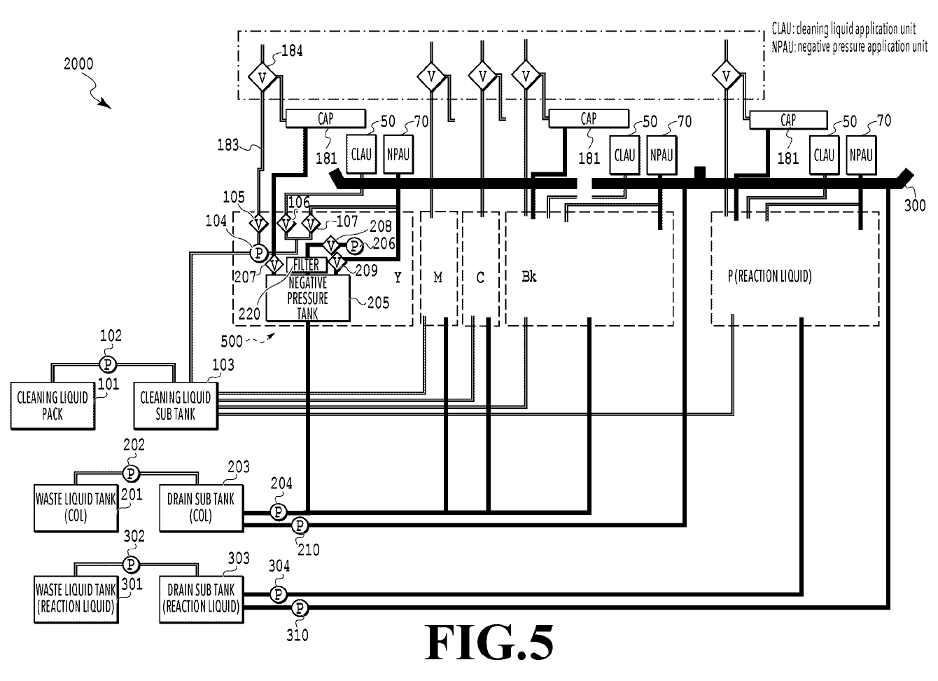

FIG. 5 is a diagram illustrating a channel configuration in the printing module 2000 in the present embodiment. Cleaning liquid supply channels, negative pressure suction channels, and waste liquid channels will be described using FIG. 5. All of the components illustrated in FIG. 5 are provided inside the printing module 2000. A cleaning liquid and negative pressure supply unit 500 is provided for each print head 22. In FIG. 5, an internal configuration of only the cleaning liquid and negative pressure supply unit 500 for yellow (Y) is illustrated for simplicity. Likewise, a capping mechanism 181, a cleaning liquid application unit 50, and a negative pressure application unit 70 are provided for each print head 22, but the configuration is illustrated only for some print heads 22 in FIG. 5 for simplicity. Each cleaning liquid and negative pressure supply unit 500 includes a cleaning liquid supply pump 104, on-off valves 105 to 107, a negative pressure tank 205, a negative pressure suction pump 206, on-off valves 207 to 209, and a filter 220.

The cleaning liquid is delivered to a cleaning liquid sub tank 103, which is a storage tank for storing the cleaning liquid, from a cleaning liquid pack 101 by a liquid delivery pump 102. The cleaning liquid and negative pressure supply unit 500 for each print head 22 (Y, M, C, Bk, P) is provided with a cleaning liquid supply pump 104. The cleaning liquid supply pump 104 can deliver the cleaning liquid from the cleaning liquid sub tank 103 to the capping mechanism 181, the cleaning liquid application unit 50, and the negative pressure application unit 70 for the corresponding print head 22. For example, the cleaning liquid supply pump 104 for Y can deliver the cleaning liquid in the cleaning liquid sub tank 103 to the capping mechanism 181, the cleaning liquid application unit 50, and the negative pressure application unit 70 for the print head 22 for Y.

Also, the on-off valves 105 to 107 in the cleaning liquid and negative pressure supply unit 500 can control the timing to supply the cleaning liquid to the capping mechanism 181, the cleaning liquid application unit 50, and the negative pressure application unit 70.

The negative pressure suction pump 206, which is connected to the negative pressure tank 205, applies a negative pressure to the capping mechanism 181 and the negative pressure application unit 70. The negative pressure can be applied to the capping mechanism 181 and the negative pressure application unit 70 through the provided on-off valves 207 to 209 through via the negative pressure tank 205. Since a cleaning liquid and negative pressure supply unit 500 is provided for each print head 22, a negative pressure can be applied independently for each print head 22 as well.

During the negative pressure suction by the capping mechanism 181 and the negative pressure application unit 70, the waste liquid sucked out of the print head 22 is stored in a drain sub tank 203, which is a storage tank for storing the waste liquid, from the negative pressure tank 205 by means of a first discharge pump 204. Further, the waste liquid is stored in a waste liquid tank 201 by means of a second discharge pump 202.

Additionally, a collection tray 300 for collecting the cleaning liquid spilling out of the cleaning liquid application unit 50 is provided. The cleaning liquid collected by the collection tray 300 is delivered to the drain sub tank 203 by a third discharge pump 210.

In a case where the waste liquid tank 201 becomes nearly full, a waste liquid tank detection sensor (not illustrated) detects it, and the user will be prompted to replace the waste liquid tank 201.

Note that the waste liquid from the reaction liquid (P) head is stored in a drain sub tank 303 for the reaction liquid by means of a fourth discharge pump 304 separately from the waste liquids through the waste liquid channels from the color ink heads (COL: Y to Bk). Further, the waste liquid is stored in a waste liquid tank 301 for the reaction liquid by means of a fifth discharge pump 302. The collection tray 300 is partitioned at a position between the color ink heads and the reaction liquid head, and the cleaning liquid used for the reaction liquid head and collected by the collection tray 300 is delivered to the drain sub tank 303 by a sixth discharge pump 310. In this way, the reaction liquid (P) and the color inks (Y to Bk) do not get mixed inside a waste liquid channel, thereby preventing the inks from being fixedly attached to the inside of the channel and closing the channel. Note that the configuration of the collection tray 300 is not limited to this, and may be a configuration in which separate collection trays are provided for the color inks (Y to Bk) and the reaction liquid (P).

In the channel configuration described above, a cleaning liquid and negative pressure supply unit 500 is individually provided for each head (Y, M, C, Bk, P). Each cleaning liquid and negative pressure supply unit 500 is provided with a cleaning liquid supply pump 104 and on-off valves 105 to 107 for controlling the supply of the cleaning liquid to respective channels. Each cleaning liquid and negative pressure supply unit 500 is also provided with a negative pressure tank 205, a negative pressure suction pump 206 for performing negative pressure suction, and on-off valves 207 to 209 for controlling the application of a negative pressure to respective elements. Thus, in the present embodiment, for each cleaning liquid and negative pressure supply unit 500 provided for a print head (Y, M, C, Bk, P), necessary electrical devices and on-off valves are grouped and unitized.

As illustrated in FIG. 3, a cap liquid supply channel 183 of the capping mechanism 181 for each print head 22 includes multiple cap upstream three-way valves 184. In the present embodiment, since five print heads 22 are provided, five cap upstream three-way valves 184 are provided corresponding to the print heads 22. The multiple cap upstream three-way valves 184 are supported on a three-way valve support member 185 by a fixing method not illustrated.

### Maintenance Process

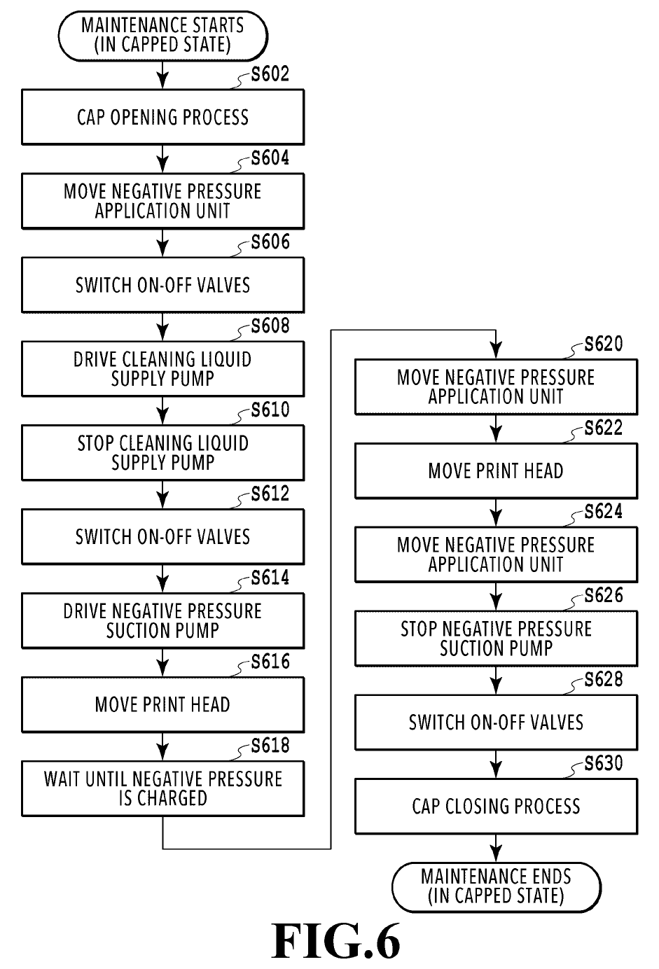

FIG. 6 is a flowchart of a maintenance process for recovering or maintaining the ejection performance of each print head 22 in the present embodiment performed such that the cleaning liquid is supplied to each negative pressure application unit 70 before generating a negative pressure. The flow in FIG. 6 starts in a state where each print head 22 and the corresponding capping mechanism 181 are in abutment with each other.

First, in step S602, the control unit 21 executes a process of separating each print heads 22 and the corresponding capping mechanism 181 from each other (hereinafter referred to as "cap opening process") by actuating the print head 22 and the capping tray 18. The cap opening process in this step results in a state where the print head 22 is not capped by the capping mechanism 181 (a state where the print head 22 and the capping mechanism 181 are out of abutment with each other). In the following, "step S_" will be abbreviated as "S_."

In S604, the control unit 21 moves the negative pressure application unit 70 from its initial position to a negative pressure application position (the position illustrated in FIG. 7A) by actuating the cleaning tray 19 and the cleaning mechanism 191.

In S606, the control unit 21 switches the opening and closing of each of the on-off valves 105 to 107 and the opening and closing of each of the on-off valves 207 to 209 to establish communication between the cleaning liquid sub tank 103 and the negative pressure application unit 70.

In S608, the control unit 21 drives the cleaning liquid supply pump 104 to supply the cleaning liquid to the negative pressure application unit 70.

In S610, the control unit 21 stops the cleaning liquid supply pump 104 in response to detecting the cleaning liquid spilling out from an opening portion of the negative pressure application unit 70. For this detection, the present embodiment employs a cleaning liquid detection unit provided at an intermediate portion of the channel, and whether the cleaning liquid has spilled out is determined and detected based on whether the cleaning liquid supply pump 104 has been driven for a predetermined time since the detection unit detects the cleaning liquid. As a result of S608 and S610, the cleaning liquid is applied to the abutment surface of the negative pressure application unit 70 that is in abutment with the print head 22.

In S612, the control unit 21 switches the opening and closing of each of the on-off valves 105 to 107 and the opening and closing of each of the on-off valves 207 to 209 to establish communication between the negative pressure tank 205 and the negative pressure application unit 70. As a result of this step, the channel connecting between the negative pressure tank 205 and the negative pressure application unit 70 shifts to an open state. Moreover, as a result of this step, the channel connecting between the cleaning liquid sub tank 103 and the negative pressure application unit 70 shifts to a non-communicating state (closed state).

In S614, the control unit 21 drives the negative pressure suction pump 206 to apply a negative pressure to the negative pressure application unit 70 via the negative pressure tank 205.

In S616, the control unit 21 moves the print head 22 into abutment with the negative pressure application unit 70. As a result of this step, the positional relationship between the print head 22 and the negative pressure application unit 70 becomes as illustrated in FIG. 7B.

In S618, the control unit 21 waits until the negative pressure in the negative pressure application unit 70 reaches a predetermined value.

In S620, the control unit 21 actuates the cleaning mechanism 191 to suck the ink out of the nozzle portions of the print head 22 through the opening portion provided in the abutment surface of the negative pressure application unit 70 that is in abutment with the nozzle surface of the print head 22 while moving the negative pressure application unit 70 in the Y direction.

In S622, the control unit 21 moves the print head 22 to separate it from the cleaning mechanism 191. As a result of this step, the positional relationship between the print head 22 and the negative pressure application unit 70 becomes as illustrated in FIG. 7A.

In S624, the control unit 21 moves the negative pressure application unit 70 from the negative pressure application position to the initial position by actuating the cleaning mechanism 191.

In S626, the control unit 21 stops the negative pressure suction pump 206 to release the negative pressure in the negative pressure application unit 70 and the negative pressure tank 205.

In S628, the control unit 21 switches the opening and closing of each of the on-off valves 105 to 107 and the opening and closing of each of the on-off valves 207 to 209 to bring the negative pressure application unit 70 into a standby state. This standby state refers to a state where the cleaning liquid sub tank 103 and the negative pressure application unit 70 do not communicate with each other and the negative pressure tank 205 and the negative pressure application unit 70 do not communicate with each other.

In S630, the control unit 21 executes a process of bringing the print head 22 into abutment with the capping mechanism 181 (hereinafter referred to as "cap closing process") by actuating the cleaning tray 19, the capping tray 18, and the print head 22. The cap closing process in this step results in a state where the print head 22 is capped by the capping mechanism 181 (a state where the print head 22 and the capping mechanism 181 are in abutment with each other). After S630, the series of processes ends.

Incidentally, the waste liquid sucked out of the print head 22 during the negative pressure suction by the negative pressure application unit 70 is stored in the drain sub tank 203 from the negative pressure tank 205 by means of the first discharge pump 204. Further, the waste liquid is stored in the waste liquid tank 201 by means of the second discharge pump 202.

As described above, in the present embodiment, the cleaning liquid is supplied to the negative pressure application unit in S608 before the negative pressure application unit is brought into abutment with the print head in S616. This reduces the frictional resistance on the surfaces of the print head and the negative pressure application unit to be brought into abutment with each other. Moreover, it becomes easier for the negative pressure application unit to follow the print head in the state where the negative pressure application unit and the print head are in abutment with each other. Accordingly, the tightness of contact between the negative pressure application unit and the print head is increased, allowing stable charging of a negative pressure.

### Channel Cleaning Process

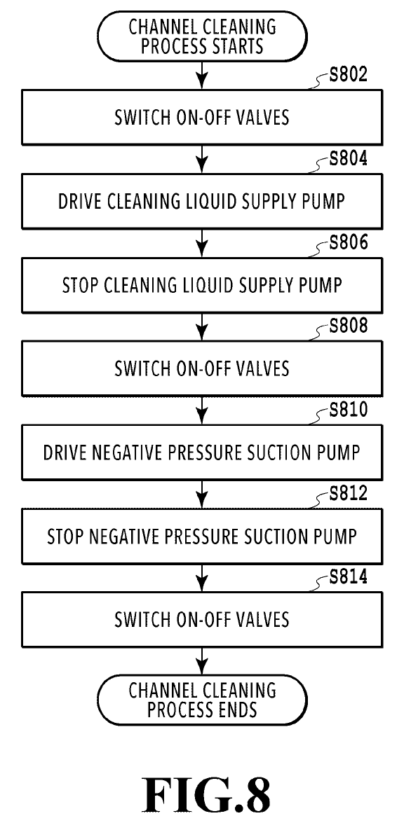

FIG. 8 is a flowchart of a process of cleaning a channel in the present embodiment (hereinafter referred to as "channel cleaning process"). The flow in FIG. 8 is executed after the maintenance process illustrated in FIGS. 7A and 7B ends.

In S802, the control unit 21 switches the opening and closing of each of the on-off valves 105 to 107 and the opening and closing of each of the on-off valves 207 to 209 to establish communication between the cleaning liquid sub tank 103 and the negative pressure application unit 70.

In S804, the control unit 21 drives the cleaning liquid supply pump 104 to supply the cleaning liquid to the negative pressure application unit 70.

In S806, the control unit 21 stops the cleaning liquid supply pump 104 in response to detecting the cleaning liquid spilling out from the opening portion of the negative pressure application unit 70.

In S808, the control unit 21 switches the opening and closing of each of the on-off valves 105 to 107 and the opening and closing of each of the on-off valves 207 to 209 to establish communication between the negative pressure tank 205 and the negative pressure application unit 70. As a result of this step, the channel between the negative pressure tank 205 and the negative pressure application unit 70 (functioning as a waste liquid collection channel) becomes ready to be cleaned.

In S810, the control unit 21 drives the negative pressure suction pump 206 to apply a negative pressure to the negative pressure application unit 70 via the negative pressure tank 205 and collect the waste liquid in the waste liquid collection channel into the negative pressure tank 205.

In S812, the control unit 21 stops the negative pressure suction pump 206 after the elapse of a predetermined time to release the negative pressure in the negative pressure application unit 70 and the negative pressure tank 205.

In S814, the control unit 21 switches the opening and closing of each of the on-off valves 105 to 107 and the opening and closing of each of the on-off valves 207 to 209 to bring the negative pressure application unit 70 into a standby state. This standby state refers to a state where the cleaning liquid sub tank 103 and the negative pressure application unit 70 do not communicate with each other and the negative pressure tank 205 and the negative pressure application unit 70 do not communicate with each other. After S814, the series of processes ends.

Incidentally, a case of executing the processes of S802 to S814 once has been presented in the above, but the processes may be repeated multiple times.

Also, the waste liquid sucked out of the print head 22 during the negative pressure suction executed by the negative pressure application unit 70 is stored in the drain sub tank 203 from the negative pressure tank 205 by means of the first discharge pump 204. Further, the waste liquid is stored in the waste liquid tank 201 by means of the second discharge pump 202.

As described above, in the present embodiment, negative pressure suction is executed through the flow in FIG. 6 (S624 in particular), and the waste liquid collection channel is cleaned through the flow in FIG. 8. This prevents the ink from getting fixedly attached to the waste liquid collection channel. Accordingly, the maintenance performance will be maintained.

### Process of Supplying Cleaning Liquid to Negative Pressure Application Unit

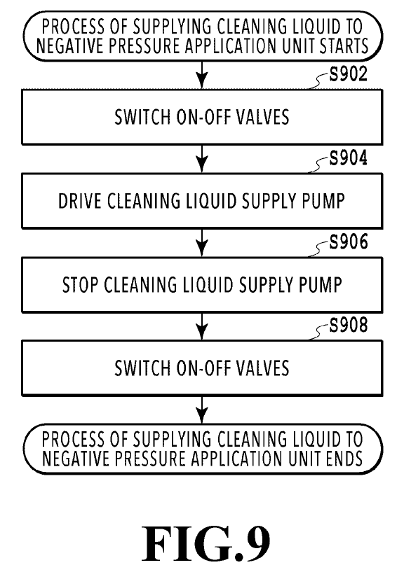

FIG. 9 is a flowchart of a process of supplying the cleaning liquid to the negative pressure application unit to maintain the negative pressure application unit moist (hereinafter "cleaning liquid supply process"). The flow in FIG. 9 is executed after the channel cleaning process illustrated in FIG. 8 ends.

In S902, the control unit 21 switches the opening and closing of each of the on-off valves 105 to 107 and the opening and closing of each of the on-off valves 207 to 209 to establish communication between the cleaning liquid sub tank 103 and the negative pressure application unit 70.

In S904, the control unit 21 drives the cleaning liquid supply pump 104 to supply the cleaning liquid to the negative pressure application unit 70.

In S906, the control unit 21 stops the cleaning liquid supply pump 104 in response to detecting the cleaning liquid spilling out from the opening portion of the negative pressure application unit 70.

In S908, the control unit 21 switches the opening and closing of each of the on-off valves 105 to 107 and the opening and closing of each of the on-off valves 207 to 209 to bring the negative pressure application unit 70 into the standby state described earlier. After S908, the series of processes ends.

As described above, in the present embodiment, after the channel cleaning process in FIG. 8, the cleaning liquid is supplied to the negative pressure application unit through the flow in FIG. 9. As a result, the negative pressure application unit is maintained moist, making it possible to prevent the ink from being fixedly attached to the negative pressure application unit. This will in turn stabilize the tightness of contact between the print head and the negative pressure application unit in subsequent negative pressure suction and thus maintain the maintenance performance.

### Advantageous Effect of Present Embodiment

As described above, in the present embodiment, a cleaning liquid supply unit supplies the cleaning liquid to the negative pressure application unit (S608) before the negative pressure application unit executes a negative pressure suction operation on the nozzles of the print head (S618 to S620 in FIG. 6). This stabilizes the tightness of contact between the print head the negative pressure application unit (suction unit).

### Other Embodiments

The technology of the present disclosure is applicable to line-head printing apparatuses, as described above, but it applicable also to serial printing apparatuses.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to stabilize the tightness of contact between a print head and a suction unit.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-056441, filed Mar. 28, 2025, which is hereby incorporated by reference wherein in its entirety.

What is claimed is:

1. A printing apparatus comprising:
a print head;
a negative pressure application unit configured to come into abutment with and apply a negative pressure to the print head;
a negative pressure tank configured to store a negative pressure to be applied to the negative pressure application unit; and
a cleaning liquid supply unit configured to supply a cleaning liquid, wherein
the cleaning liquid supply unit supplies the cleaning liquid to the negative pressure application unit before the negative pressure application unit executes a negative pressure suction operation on the print head.

2. The printing apparatus according to claim 1, wherein
the print head includes a nozzle plate,
a plurality of nozzle arrays are formed in the nozzle plate, and
the negative pressure application unit comes into abutment with the nozzle plate in a case of executing the negative pressure suction operation on the print head.

3. The printing apparatus according to claim 2, further comprising:
a tank configured to store the cleaning liquid; and
a cleaning liquid application unit configured to apply the cleaning liquid, wherein
a first channel for supplying the cleaning liquid to the negative pressure application unit is provided between the tank and the negative pressure application unit.

4. The printing apparatus according to claim 3, wherein a second channel for collecting a waste liquid resulting from the negative pressure suction operation on the print head is provided between the negative pressure application unit and the negative pressure tank.

5. The printing apparatus according to claim 4, wherein the first channel is closed and the second channel is open in a case where the negative pressure suction operation is executed on the print head.

6. The printing apparatus according to claim 5, wherein a cleaning process of cleaning the second channel is executed after the negative pressure suction operation is executed on the print head.

7. The printing apparatus according to claim 6, wherein a supply process of supplying the cleaning liquid to the negative pressure application unit is executed after the cleaning process is executed.

8. The printing apparatus according to claim 7, wherein the cleaning liquid supply unit applies the cleaning liquid to an abutment surface of the negative pressure application unit that comes into abutment with the print head.

9. A method of controlling a printing apparatus including
a print head,
a negative pressure application unit configured to come into abutment with and apply a negative pressure to the print head,
a negative pressure tank configured to store a negative pressure to be applied to the negative pressure application unit, and
a cleaning liquid supply unit configured to supply a cleaning liquid,
the method comprising causing the cleaning liquid supply unit to supply the cleaning liquid to the negative pressure application unit before the negative pressure application unit executes a negative pressure suction operation on the print head.

10. A non-transitory computer readable storage medium storing a program for causing a computer to execute a method of controlling a printing apparatus including
a print head,
a negative pressure application unit configured to come into abutment with and apply a negative pressure to the print head,
a negative pressure tank configured to store a negative pressure to be applied to the negative pressure application unit, and
a cleaning liquid supply unit configured to supply a cleaning liquid,
the method comprising causing the cleaning liquid supply unit to supply the cleaning liquid to the negative pressure application unit before the negative pressure application unit executes a negative pressure suction operation on the print head.
